(19) United States
(12) Patent Application Publication
(10) Pub. No.: US 2004/0202386 A1
(43) Pub. Date: Oct. 14, 2004

(54) Automatic paper to digital converter and indexer

(75) Inventor: Douglas B. Quine, Bethel, CT (US)

Correspondence Address: Pitney Bowes Inc., Intellectual Property & Technology Law Department, 35 Waterview Drive, P.O. Box 3000, Shelton, CT, 06484, US

(73) Assignee: Pitney Bowes Incorporated, Stamford, CT

(21) Appl. No.: 10/412,518

(22) Filed: Apr. 11, 2003

(51) Int. Cl. G06K 9/54

(52) U.S. Cl. 382/305

(57) ABSTRACT

A method and system for processing a paper document, so as to enhance coordination of the paper document with its electronic counterpart, are presented. The paper document is scanned to create an electronic twin having searchable content, and an identification code is put on the paper document. Then the electronic twin and the identification code are stored in a searchable database. The identification code is ascertainable from a search result, and the paper document is then retrievable using the ascertained identification code.

### FIELD OF THE INVENTION

The invention disclosed herein relates generally to paper processing devices and systems, and more particularly to facsimile machines, copier machines, scanners, and sorters.

### BACKGROUND OF THE INVENTION

Companies today are overwhelmed by the volume of paper documents that cannot be efficiently accessed, indexed, searched, or digitally distributed to those who need to handle the documents. Tremendous costs are incurred finding and filing paper documents. Many people need a means to obtain access to the contents of a printed document when they do not have access to the original text.

Such printed documents may be fax copies; they may be documents printed from a computer, and the recipient does not have access to the digital original; they may be typewritten documents (handwritten documents are becoming increasingly amenable to conversion to full digital text).

Many invoices, contracts, purchase orders, and bills are delivered by paper copy because of the need for signatures, and there is a current tendency to use mail or fax for that delivery, due to the lack of practical means for verifying digital signatures between two arbitrary parties. The paperless office is not yet a reality, and there remains frustration at trying to find information in paper documents, costs of filing and finding documents, inability of computer users to find data in faxed documents, et cetera. There is a compelling need for efficient handling of incoming documents, especially if they are being faxed, copied, relayed for approvals, or duplicated for wider distribution.

Optical character recognition (OCR) technology is available on most scanners for home and professional use, and this can be helpful in bridging the paper/digital divide. OCR has been in use for many years, as can be seen from McWaters, et al., “OCR and Bar code reader using multi port matrix array,” (U.S. Pat. No. 4,408,344). For example, lawsuit software offers the ability to scan and OCR documents for preservation, and index access on CD or in computer files for further access. These systems scan, OCR, and write to CD, for lawsuits. Another useful technology is to put a fluorescent mark on the back of originals as they are scanned, to show which items have been processed. FindFile (Microsoft Windows) and Alta Vista software support complex indexing of a set of computer files or documents, and also support ready retrieval of data from a particular document. However, all of these existing technologies remain fragmented, and have yet to be unified into a coherent system for enhancing coordination of business papers with their electronic counterparts.

Additionally, various other prior art is known to store digital images of documents. Titles, authors, keywords, or summaries may be manually typed into a database to provide some searching capability for finding particular electronically stored documents. But, again, the coordination of business papers with electronic counterparts is lacking.

### SUMMARY OF THE INVENTION

The present invention provides a method and system for managing, indexing, and searching the contents of paper documents using digital scanning, character recognition, and indexing. The method does not attempt to substitute the paper document with a digital version.

Rather the scanned content can be electronically searched and the results can be related back to the original paper document.

The invention allows a document to be converted to a digital text and graphics document, whereas a scanned image would not enable searchable access to the document except by a human reader (it also requires much more storage space). The invention enables people seeking access to the document a ready means to search electronic files for information in those documents. The invention also allows people the ability to cut and paste pieces of the document, and augment the document in further works, without retyping the entire document or losing track of the original in electronic and/or paper form.

According to one preferred embodiment of this invention, a combined copier/scanner/barcoder scans the document, runs an OCR process, saves the OCR file, and applies a tracking barcode (with optional human readable identifier) to the document so that it can be identified or filed. When someone seeks content of a particular subject, they can search the digital document archive for the text strings of interest, and this will direct them to the appropriate document. OCR is imperfect, and the cleanup process may not be cost effective for bulk documents, and therefore a digital image of the document can be saved together with the OCR text, for ready access without tracking down the master document. This capability of the present invention should be a standard component of all copiers and all fax machines.

The tracking barcode of the present invention allows access back to the original, since there is a handy means to identify the original document. This capability can also be easily implemented in fax or copier systems, since, for example, they already have the processing power and printing capability to add a barcode and serial number. The present invention also provides a rapid means to conveniently store the original, by the reference number. Since the information is accessible digitally, it is not necessary to use a time consuming decision process to determine the proper categories and cross references for storing the document. And, since the scanned image can be associated with the text (and perhaps separate graphics), it is even possible to maintain a digital copy of the document and discard the paper original.

This method and system provide a high-speed means for the encoding and sorting of documents sent, for example, through fax machines using postal sorting systems.

Accordingly, the present invention includes a method and system for processing a paper document, so as to enhance coordination of the paper document with its electronic counterpart. The paper document is scanned to create an electronic twin having searchable content, and an identification code is put on the paper document. Then the electronic twin and the identification code are stored in a searchable database. The identification code is ascertainable from a search result, and the paper document is then retrievable using the ascertained identification code.

This invention also covers a system for processing a paper document at a particular business, so as to enhance coordination of business papers with their electronic counterparts. This system includes an identification code assignment module, for sending an identification code affixing signal and an identification code filing signal which both have magnitudes indicative of the identification code. The system further includes an identification code affixing device, responsive to the identification code affixing signal, for affixing the identification code to the paper document, if the paper document does not already have an identification code affixed. Additionally, the system includes a database for the business, responsive to the identification code filing signal, for filing an electronic twin of the paper document in the database according to the identification code, if the electronic twin is not already in the database. The electronic twin is retrievable by the identification code, and the identification code applied to the paper document is at least partly machine readable.

This technology allows existing paper documents to be linked to each other by their tracking ID numbers, thereby avoiding the need to save duplicate copies of paper documents. In some law offices, 50% of their stored files represent duplicated paper documents, but there is no means to determine which documents are duplicates. Using the present technology, document ID numbers can be compared and paper duplicates readily identified. Furthermore, as documents are logged into an archive box for external storage by scanning their document barcodes, the database is able to alert the file clerk that another copy of that document was already logged for storage. Document triplicates and quadruplets can be eliminated; only the paper/electronic twins need be retained.

The present system also supports document revision control. If a request is made for a particular document: 12345.doc, the database can alert the user that the document has been revised elsewhere into a new document 12346.doc and offer the more current version if desired.

### BRIEF DESCRIPTION OF THE DRAWINGS

FIG. 1. is a flow chart illustrating a preferred embodiment of the method according to the present invention.

FIG. 2. is a block diagram illustrating a preferred embodiment of the system according to the present invention.

FIG. 3. is a block diagram illustrating a further system and method according to the present invention.

### BEST MODE FOR CARRYING OUT THE INVENTION

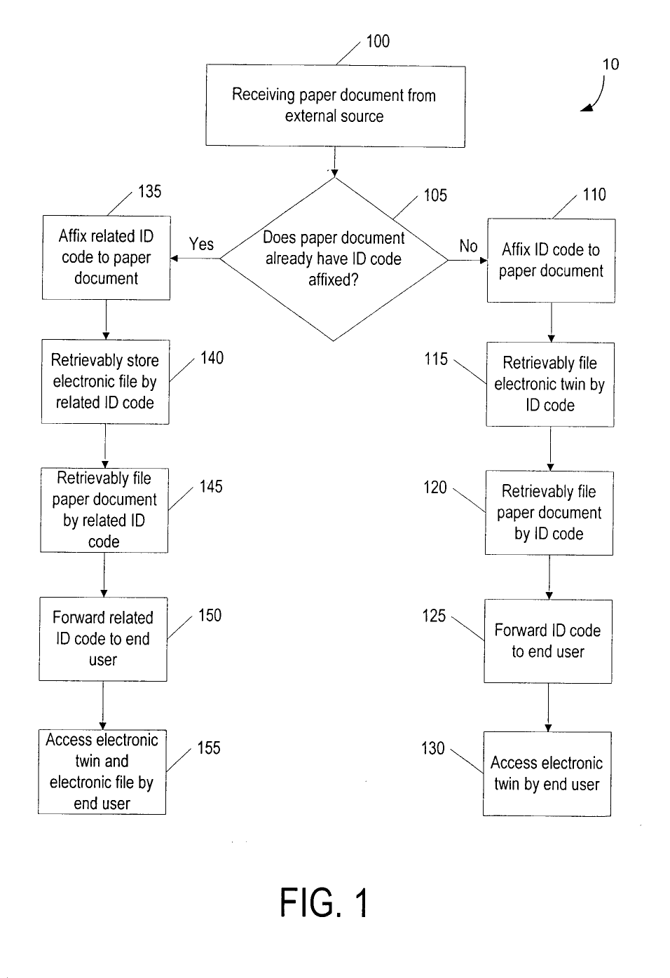

FIG. 1 is a flow chart illustrating a method 10 according to the present invention. A paper document is received from an external source at step 100. This may occur via an envelope received by U.S. mail or by private carrier delivery; it may also be a paper printing out a message received electronically, via facsimile or via email. Document originators may also prebarcode their documents as they are printed to preload their database with the document information and provide for upstream linkages by recipients. In any case, a determination 105 is then made whether the paper document already has an identification code affixed. For example, the paper document may be a signed copy of a document that originated from the business, or a filled-out form that originated at the business.

If the paper document does not already have an identification code affixed, then such a code is affixed at step 110. Then, an electronic twin of the paper document is filed 115 in a database for the business so that it is retrievable by the identification code that has been affixed to the paper document. The word “twin” is used here advisedly, to emphasize that the electronic twin may have been created either before or after the paper document was created, whereas the word “copy” would suggest the latter situation only. In any event, the paper document is also filed 120 so that it is retrievable by the identification code. Then the identification code is forwarded 125 to an end user within the business, with or without the electronic twin, and in the latter case the end user can then decide to access 130 the electronic twin, or access the paper document if he prefers, by inputting the identification code. An alternate embodiment could allow filing documents according to a traditional system, and then, when retrieved, the barcode allows the user immediate access to an electronic copy, either for forwarding to another person or to create a revised or updated electronic version.

If, however, the paper document does 105 already have an identification code affixed, then a different procedure is followed. If the paper document already has an identification code affixed (e.g. indicating that the document was previously processed by the business) then a related identification code is affixed 135 to the document, and an electronic file corresponding to the paper document is stored 140 in a database so as to be retrievable according to the related identification code. Likewise, the paper document is retrievably filed 145 according to the related identification code. Then the related identification code if forwarded 150 to an end user within the business (such as the addressee), who can use the related identification code to access 155 the electronic file and/or the electronic twin corresponding to the identification code to which the related identification code is related; the user could use the related identification code to access the corresponding papers.

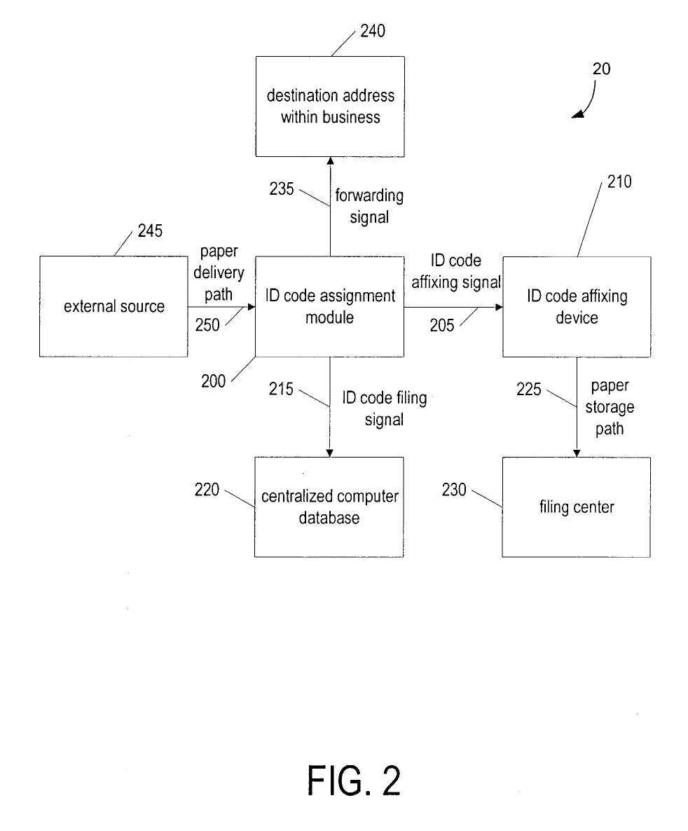

FIG. 2 illustrates one preferred system 20 for performing the method of the present invention. The central feature of this system is an identification code assignment module 200 which assigns an identification code to a paper document, typically without regard to the type of contents in the paper document. For example, the identification code may simply reflect the date and time when the identification code was assigned. In any case, the identification code assignment module will then send an identification code affixing signal 205 to an identification code affixing device 210 which then affixes the identification code to the front or rear of the paper document. This device may advantageously include means to check the paper document for a “clear zone” so that the identification code can be affixed without obscuring existing text or graphics. The identification code assignment module 200 also sends an identification code filing signal 215 to a database 220 which conveys an electronic version of the paper document to the database 220 along with the identification code. The database serves the whole business, or serves a portion of the business including a plurality of offices, and therefore can be a centralized computer database. The database can also serve multiple businesses through a network, telecommunications, or internet connection to a shared or common database. The identification code need not be a printed barcode; it might be a radio frequency identification (RFID) tag which is embedded in the paper document and which is encoded or recognized electronically as the document passes through the scanner, copier, or sorter. If printer, scanner, or copier paper is utilized which contains such RFID tags then they can be encoded at the time of printing for remote recognition or retrieval and be entered into the database as are barcoded documents.

The paper document will often have arrived at the business from an external source 245, so the paper document must be delivered 250 to the business. Such a paper document will frequently arrive addressed to a specific person or destination within the business, or it may be addressed to a specific destination after it arrives, and in either case the identification code assignment module 200 will send a forwarding signal 235 to the specific destination 240 to alert the destination of the identification code, so that the destination can access the document in paper and/or electronic form using the identification code. After the identification code affixing device 210 affixes the identification code to the paper document, the paper document is sent via a paper storage path 225 to a filing center 230 where it is filed according to the identification code, or according to some other filing system. In the latter case, it will sometimes be useful for the business to maintain a cross-reference of identification codes to filing locations; alternatively the affixing device 210 can affix not just the identification code but also can affix to the paper document a unique detectable element that can later be located by a detector.

The identification code can be made available from the electronic twin as well as from the paper document, so that someone using an electronic document can easily retrieve its paper counterpart. The retrieval can be manual, or can be automated so that requesting the hard copy of an electronic document retrieves it automatically (much as a juke box retrieves a record or compact disc). It may be advantageous, in the case of manual retrieval, for the identification code to be at least partly human readable, in addition to being at least partly machine readable. The machine readable aspect comes in handy when a user has a paper document in hand, and can swipe the identification code over a scanner such as a barcode scanner attached to his desktop computer, thus logically linking, or quickly bringing up, the electronic twin on the user's screen monitor. The barcode on a hard copy document thus allows the end user to scan that barcode and electronically retrieve the electronic version on a computer screen for electronic transfer to a colleague or email. The human readable identification text also allows an operator without a barcode scanner to manually enter the identification number from a paper document and retrieve the electronic version. If the identification code includes some alphanumeric text or a graphic, then a human can read at least part of that identification.

It is very typical for a business to produce at least one paper duplicate of a paper document by copying or scanning, in which case at least one related code can advantageously be attached respectively to the paper duplicates. The electronic twin is then retrievable not just by the identification code but also by the at least one related code; the at least one related code is related to the identification code and in fact may include the identification code. For example, when a copy is made, a number can simply be added to the identification code.

The electronic twin will preferably have a searchable text, and be write protected, in which case copies of the electronic twin can be created and modified. However, the electronic twin can also be simply an image file, from which a searchable text may or may not be extractable.

It is useful for any modified copies to get a variant document identification (e.g. document 12345 version B). The twin documents and their copies should be identifiably linked to each other but should be linked in such a way as to distinguish them from revised documents. Revised documents get modified identification information, although the linkage back to the “source” or “root” document can be maintained; this allows people requesting the original document (which may be protected against alteration) to be alerted to the existence of newer versions.

The identification code, and the paper document to which the identification code is affixed, will ideally have a location in the business that is detectable directly or indirectly by an identification code detecting device. Such devices exist in the prior art in order to mark file folders in such a way that they can be easily found using a detector, and the same thing can be done for individual paper documents.

The identification code of the present invention can be used for tracking, tracing, or retrieving the electronic twin or the paper document. The electronic twin may advantageously be created from the paper document using optical character recognition (OCR). According to a preferred embodiment of the invention, a digital copier or digital fax captures a scanned image of a document. Then the image is sent to OCR scanner software to convert the image to text, either on the copier/fax, on a server, or on a local computer. A sequential (or logical or chronological) ID number is then assigned to the document, and the text of the document is stored in the document computer or database in the name of the ID number. A simple implementation would be to store each item as a Word document with the ID number as the name, for example, “12345.doc.”

Optionally, the scanned image of the document is also stored to provide a reference copy, in case the OCR process did not correctly read all the document, or in case there are signatures for visual verification. A simple implementation would be to store each item as an efficient format graphics document with the ID number as the name, e.g. “12345.gif.”

Then the document ID is barcoded and printed in a human readable form on the original document, on the face or the reverse, in visible or invisible (barcode) ink, which allows reference from the computer documents to the original and the reverse. Digital copiers have the capability of applying a sequence number to a document, and they could be enhanced to also include a barcode. Logging of identification codes may be used to verify that the document has been received or has passed through a particular step of a process.

The physical paper documents can be filed locally. The electronic document image can now be distributed for action, processing, approval. The text document can be accessed by those seeking documents containing particular information. The documents can now be found if they are missing, simply by searching for a text string which exists within that document.

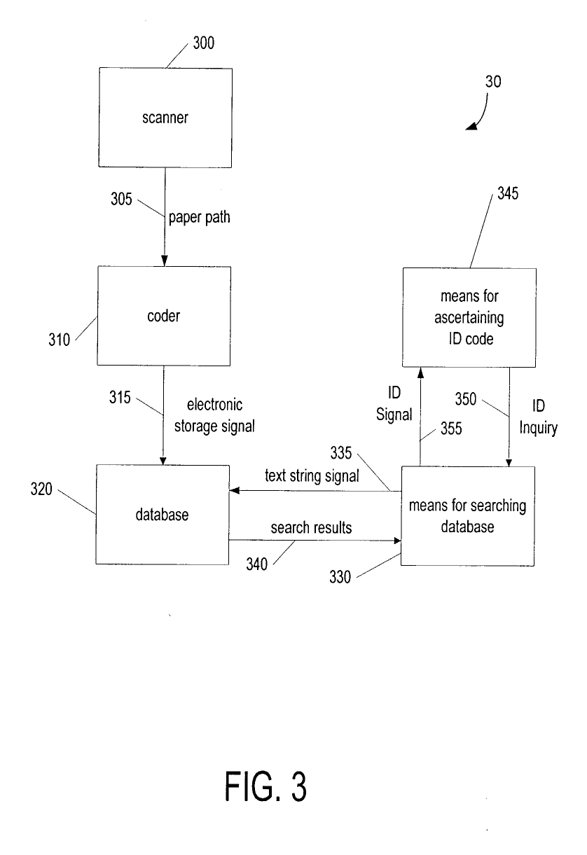

FIG. 3 illustrates a further preferred embodiment of the present invention. A scanner 300 scans a paper document to create an electronic twin, and the document proceeds along a paper path 305 to a coder 310 which puts an identification code on the document. The order is not important here, and the identification code could just as well be put on the paper document before the scanning occurs. In any case, an electronic storage signal 315 then carries the electronic twin to a database 320.

A means for searching the database, 330, can then be used to send a text string signal 335 to the database 320, which will return search results 340. The identification code of a search result can be obtained, so that the paper document corresponding to the search result can be obtained using the identification code. In other words, a means for ascertaining ID 345 sends an ID inquiry 350 which elicits an ID signal 355 providing the identification code.

There are several possible ways to implement this embodiment. It could be implemented on a copier, so all documents can be automatically scanned and indexed. It could be implemented on a fax machine, so all documents can be automatically scanned and indexed. Or, it could be implemented on an incoming mail system or mail sorter, routing images for scanning and then routing the digital documents to the parties responsible for approval (invoices), decisions (insurance claims), or review. This system can stop the paper flow in the mailroom and allow documents to be distributed digitally, with search access to the content. An additional implementation would be to use the fax for distributing/sorting automatically to the recipient on a community fax system.

Conversion of documents from paper to electronic form provides a number of benefits, including the ability to distribute the document more quickly, the ability to distribute simultaneously to multiple destinations, and the ability to contain any biohazards or toxins in the mail, and immediately forward the document content to “high risk” individuals without any hazards (testing for such hazards is often a time-consuming process that delays mail delivery).

For document encoding, a standardized public recipient identification number such as employee, social security or telephone number (5 digits or 9 digits padded with zeros) is advantageously appended to a fax address. A program which automatically creates POSTNET barcodes from ZIP codes then generates a POSTNET barcode beneath the address which is printed in the top third of the document by the sender. Such functionality is widely available in word processing or utility programs on DOS, Windows, and Macintosh computers.

The document is faxed normally. Upon receipt, the document is trifolded.

The document may be fed through a tabletop paper folder (i.e. Pitney Bowes model 6090), or fax systems could be designed with integrated folders which fold each completed document. Folded received fax documents, with the barcoded side faced, are passed through a mail sorting machine with a sort plan. The sort plan can be used to sequence all mail pieces by office, or to the individual employee, at rates of 10,000 to 30,000 documents per hour.

Several additional embodiments can be easily described. A document is received at a business, scanned, a barcode is applied to that document, and the electronic representation of the document is archived for future computer access, and logically related to the hard copy document. This would be a two way street: the hard copy document points to the computer version, and the computer version points to the hard copy.

A copier, scanner, sorter, or fax system, which scans documents, extracts image information from the image of a document, possibly stores the content information, and applies an associated barcode (possibly with human readable alphanumeric text as well) to the document on its front or rear.

A copier, scanner, sorter, or fax system, which scans documents, extracts image information from the image of a document, stores image information and associated character information obtained via optical character recognition, and applies a tracking, tracing, retrieval barcode (possibly with human readable alphanumeric text as well) to the document on its front or rear.

A copier, scanner, sorter, or fax system, which scans documents, extracts image information from the image of the document, stores image information and associated character information obtained via optical character recognition, and logically links this document to a source or duplicate document already existing in an electronic storage system.

These additional embodiments have various applications. Such a barcode can be used to route the document to the internal destination address, for example to a read recipient name on an incoming fax, and automatically route a fax to that individual. Such a barcode can be used for tracking and tracing the delivery of such a document. Such a barcode can be used to enable the retrieval of the original document from storage. Such a system and barcode can be used to enable comparison and retrieval of related and duplicated documents within an enterprise. Such a system can be used to allow electronic access to electronic representations of documents, with access to the document electronic image or the physical hardcopy document as necessary. Such a system can provide means to cross link multiple copies of a single document, and/or provide rapid means to determine that multiple simultaneous copies of a document are indeed duplicates of the same document (e.g. multiple copies of a document receive the same code number with a copy number “abcdefgh copy 1”). A computer may then determine from the OCR process that document “abcdefgh” with copies 1 to 10 is the same document as document “stuvwxyz” with copies 1 to 3 made on the same or a different copier. When an electronic document is revised, the preexisting electronic copies can be flagged in the computer system as being obsolete or previous copies of that document. Likewise, paper copies can be flagged as being duplicate, previous, or obsolete when the paper copies are retrieved (manually or automatically).

Certain changes may be made in the above best mode embodiments without departing from the scope of the invention, as will be understood by those skilled in the art. It is intended that all matter contained in the above description or shown in the accompanying drawings shall be interpreted as illustrative and not in a limiting sense. The invention disclosed herein can be implemented by a variety of combinations of hardware and software, and those skilled in the art will understand that those implementations are derivable from the invention as disclosed herein.

What is claimed is:

1. A method of processing a paper document, so as to enhance coordination of the paper document with its electronic counterpart, comprising the steps of:
scanning the paper document to create an electronic twin having searchable content;
putting an identification code on the paper document; and
storing the electronic twin and the identification code in a database wherein the database is searchable;
searching the database for particular contents and retrieving the identification code for a document satisfying the search; and
retrieving the paper document using the identification code.

2. The method of claim 1 wherein the identification code is at least partly readable by a machine, and further comprising the step of automatically retrieving the electronic twin from the database using the identification code from the searching step.

3. The method of claim 1 further comprising the step of write protecting the electronic twin in the database, and wherein copies of the electronic twin are modifiable and including the step of identifying modified copies of the electronic twin.

4. The method of claim 1 wherein the paper document contains information that has arrived at an address from an external source, the method further comprising the step of forwarding the identification code to an end user at the address.

5. The method of claim 2 wherein the identification code includes human readable alphanumeric text and also machine readable code that is derivable from the alphanumeric text.

6. The method of claim 1 further comprising the step of putting the identification code on the paper document in a physical form having a location that is detectable by a detecting device.

7. The method of claim 1 further including the steps of
printing an electronic file that is a modified version of the electronic twin;
including a second identification code that is related to the identification code of the paper document on the modified version, and
wherein the electronic file and the electronic twin are both retrievable from the database by the identification code or by the second identification code.

8. The method of claim 7 wherein the second identification code contains the identification code.

9. The method of claim 1 further comprising the step of accompanying the electronic twin in the database with a corresponding image file, or the step of creating the electronic twin using optical character recognition.

10. The method of claim 1 wherein the identification code is for tracking, tracing, or retrieving the electronic twin or the paper document.

11. The method of claim 1 further comprising the steps of scanning the identification code affixed to the paper document, and logically linking to the electronic twin based upon the scanned identification code.

12. The method of claim 1 wherein the identification code comprises a barcode, and wherein the identification code is unrelated to document content type.

13. The method of claim 1 wherein the identification code comprises information about the chronological time at which the identification code is put on the paper document.

14. The method of claim 1 wherein the step of putting the identification code on the paper document includes finding a clear zone where the identification code will not obscure existing text or graphics.

15. The method of claim 1 further comprising the step of embedding the paper document with a radio frequency identification tag, and wherein the step of putting an identification code on the paper document utilizes the radio frequency identification tag.

16. The method of claim 3 wherein modified files receive modified names that distinguish the modified files from unmodified files.

17. A system for processing a paper document to enhance coordination of business papers with their electronic counterparts, comprising:
a scanner for scanning the paper document to create an electronic twin having searchable contents;
a coder for putting an identification code on the paper document;
a database for storing the electronic twin and the identification code;
means for searching the database; and
means for ascertaining the identification code from a search result so that the paper document is then retrievable using the ascertained identification code.

18. The system of claim 17 wherein the identification code is at least partly readable by a machine, and
wherein the electronic twin is automatically retrievable from the database in response to the machine reading at least part of the identification code.

19. The system of claim 17 wherein the electronic twin in the database is write protected, and wherein copies of the electronic twin are modifiable and modified copies of the electronic twin are marked as modified.

20. The system of claim 17 wherein the paper document contains information that has arrived at an address from an external source, the system further comprising the step of forwarding the identification code to an end user at the address.

21. The system of claim 18 wherein the identification code includes human readable alphanumeric text and also machine readable code that is derivable from the alphanumeric text.

22. The system of claim 17 wherein the identification code is put on the paper document in a physical form having a location that is detectable by a detecting device.

23. The system of claim 17
wherein printing an electronic file that is a modified version of the electronic twin results in a second paper document including a second identification code related to the identification code of the paper document, and
wherein the electronic file and the electronic twin are both retrievable from the database by the identification code or by the second identification code.

24. The system of claim 23 wherein the second identification code contains the identification code.

25. The system of claim 17 wherein the electronic twin is accompanied in the database by a corresponding image file.

26. The system of claim 17 wherein the identification code is for tracking, tracing, or retrieving the electronic twin or the paper document.

27. The system of claim 17 further comprising the steps of scanning the identification code affixed to the paper document, and logically linking to the electronic twin based upon the scanned identification code.

28. The system of claim 17, wherein the identification code comprises a barcode, and wherein the identification code is unrelated to document content type.

29. The system of claim 17, wherein the identification code comprises information about the chronological time at which the identification code is put on the paper document.

30. The system of claim 17, wherein the coder has a capability to locate a clear zone where the identification code will not obscure existing text or graphics.

31. The system of claim 17, wherein the paper document has an embedded radio frequency identification tag and wherein the coder places the identification code into the embedded radio frequency identification tag.

32. The system of claim 19, wherein modified files have modified names that distinguish the modified files from unmodified files.

33. The system of claim 17 wherein the electronic twin is created using optical character recognition.
